(19) United States
(12) Patent Application Publication
(10) Pub. No.: US 2026/0127704 A1
(43) Pub. Date: May 7, 2026

(54) IMAGE ENHANCEMENT METHOD, ELECTRONIC DEVICE AND STORAGE MEDIUM

(71) Applicant: Smarter Silicon (Shanghai) Technologies Co., Ltd., Shanghai (CN)

(72) Inventor: Yilan WANG, Shanghai (CN)

(21) Appl. No.: 19/370,244

(22) Filed: Oct. 27, 2025

(30) Foreign Application Priority Data
Nov. 4, 2024 (CN) 202411563375.9

(51) Int. Cl. G06T 3/40; G06N 3/0455; G06N 3/088; G06N 3/09

(52) U.S. Cl. CPC G06T 3/40; G06N 3/0455; G06N 3/088; G06N 3/09

(57) ABSTRACT

An image enhancement method, an electronic device, and a storage medium are provided in the present disclosure. The method includes performing down-sampling at a plurality of levels on a first image to obtain a plurality of encoding features with different sampling parameters; performing up-sampling at a plurality of levels on an encoding feature, obtained from down-sampling at a last level, to obtain a plurality of decoding features with different sampling parameters; and obtaining a second image based on a decoding feature obtained from up-sampling at a last level, where a resolution of the second image is higher than a resolution of the first image. Up-sampling at each non-first level includes fusing a decoding feature, obtained from up-sampling at a previous level, with an encoding feature of a same sampling parameter to obtain a fused feature, and performing up-sampling on the fused feature.

### CROSS-REFERENCE TO RELATED APPLICATION

The present disclosure claims the priority of Chinese Patent Application No. 202411563375.9, filed on Nov. 4, 2024, the content of which is incorporated herein by reference in its entirety.

### TECHNICAL FIELD

The present disclosure generally relates to the field of image processing technology, and, more particularly, relates to an image enhancement method, an image enhancement device, an image enhancement model and a training method thereof, and an electronic device.

### BACKGROUND

Image enhancement is a method for improving image visual quality. The primary purpose of image enhancement is to improve the visual quality and image resolution (i.e., clarity).

Current image enhancement solutions may use a classic U-shaped network to enhance low-quality original images to high-quality images. However, the image enhancement performance of the classic U-shaped network may be poor. To improve the image enhancement performance of the U-shaped network, a low-resolution feature search module may be added between an encoding module and a decoding module of the U-shaped network to extract highly discriminative features needed for enhancement. Furthermore, the decoding module may decode such highly discriminative features to produce high-quality images.

The addition of the low-resolution feature search module may improve image enhancement performance. However, the scale of the low-resolution feature search module may be relatively large, which may significantly increase computational complexity of entire image enhancement network, and result in slow network speed and difficult network deployment.

### SUMMARY

One aspect of the present disclosure provides an image enhancement method. The image enhancement method includes performing down-sampling at a plurality of levels on a first image to obtain a plurality of encoding features with different sampling parameters; performing up-sampling at a plurality of levels on an encoding feature, obtained from down-sampling at a last level, to obtain a plurality of decoding features with different sampling parameters; and obtaining a second image based on a decoding feature obtained from up-sampling at a last level, where a resolution of the second image is higher than a resolution of the first image. Up-sampling at each non-first level includes fusing a decoding feature, obtained from up-sampling at a previous level, with an encoding feature of a same sampling parameter to obtain a fused feature, and performing up-sampling on the fused feature; and a process of obtaining a fused feature of at least one non-first level includes fusing a decoding feature, obtained from up-sampling at a previous level, with an encoding feature of a same sampling parameter according to a pre-learned fusion parameter.

Another aspect of the present disclosure provides an electronic device. The electronic device includes a memory, configured to store a computer program; and one or more processors, configured to, when the computer program is executed, perform an image enhancement method. The image enhancement method includes performing down-sampling at a plurality of levels on a first image to obtain a plurality of encoding features with different sampling parameters; performing up-sampling at a plurality of levels on an encoding feature, obtained from down-sampling at a last level, to obtain a plurality of decoding features with different sampling parameters; and obtaining a second image based on a decoding feature obtained from up-sampling at a last level, where a resolution of the second image is higher than a resolution of the first image. Up-sampling at each non-first level includes fusing a decoding feature, obtained from up-sampling at a previous level, with an encoding feature of a same sampling parameter to obtain a fused feature, and performing up-sampling on the fused feature; and a process of obtaining a fused feature of at least one non-first level includes fusing a decoding feature, obtained from up-sampling at a previous level, with an encoding feature of a same sampling parameter according to a pre-learned fusion parameter.

Another aspect of the present disclosure provides a non-transitory computer-readable storage medium containing a computer program that, when being executed, causes one or more processors to perform an image enhancement method. The image enhancement method includes performing down-sampling at a plurality of levels on a first image to obtain a plurality of encoding features with different sampling parameters; performing up-sampling at a plurality of levels on an encoding feature, obtained from down-sampling at a last level, to obtain a plurality of decoding features with different sampling parameters; and obtaining a second image based on a decoding feature obtained from up-sampling at a last level, where a resolution of the second image is higher than a resolution of the first image. Up-sampling at each non-first level includes fusing a decoding feature, obtained from up-sampling at a previous level, with an encoding feature of a same sampling parameter to obtain a fused feature, and performing up-sampling on the fused feature; and a process of obtaining a fused feature of at least one non-first level includes fusing a decoding feature, obtained from up-sampling at a previous level, with an encoding feature of a same sampling parameter according to a pre-learned fusion parameter.

Other aspects of the present disclosure may be understood by those skilled in the art in the light of the description, the claims, and the drawings of the present disclosure.

### BRIEF DESCRIPTION OF THE DRAWINGS

To more clearly illustrate the technical solutions of embodiments of the present disclosure, accompanying drawings needed in embodiments of the present disclosure are briefly described hereinafter. Obviously, accompanying drawings described below may be some embodiments of the present disclosure. Those skilled in the art may obtain other accompanying drawings based on above-mentioned accompanying drawings without creative work.

FIG. 1 illustrates an implementation flowchart of an image enhancement method according to various embodiments of the present disclosure.

FIG. 2 illustrates an implementation flowchart of fusing a decoding feature obtained from up-sampling at previous level with an encoding feature of the same sampling parameter using a pre-learned fusion parameter according to various embodiments of the present disclosure.

FIG. 3 illustrates an implementation flowchart of weighted fusing a decoding feature obtained from up-sampling at previous level with an encoding feature of the same sampling parameter based on a first weight according to various embodiments of the present disclosure.

FIG. 4 illustrates another implementation flowchart of weighted fusing a decoding feature obtained from up-sampling at previous level with an encoding feature of the same sampling parameter based on a first weight according to various embodiments of the present disclosure.

FIG. 5 illustrates a structural schematic of an enhancement network according to various embodiments of the present disclosure.

FIG. 6 illustrates another structural schematic of an enhancement network according to various embodiments of the present disclosure.

FIG. 7 illustrates another structural schematic of an enhancement network according to various embodiments of the present disclosure.

FIG. 8 illustrates a structural schematic of an initial network according to various embodiments of the present disclosure.

FIG. 9 illustrates another structural schematic of an initial network according to various embodiments of the present disclosure.

FIG. 10 illustrates an implementation flowchart of performing supervised training on a first encoding module using a first image set based on a pre-trained network according to various embodiments of the present disclosure.

FIG. 11 illustrates an implementation flowchart of performing supervised training on a fusion module using a first image set based on a pre-trained network according to various embodiments of the present disclosure.

FIG. 12 illustrates a structural schematic of an image enhancement device according to various embodiments of the present disclosure.

FIG. 13 illustrates a structural schematic of a model training device according to various embodiments of the present disclosure.

FIG. 14 illustrates a structural schematic of an electronic device according to various embodiments of the present disclosure.

### DETAILED DESCRIPTION

To clearly describe the objectives, technical solutions and advantages of the present disclosure, the technical solutions of the present disclosure are further described in detail below in combination with accompanying drawings and embodiments. Described embodiments should not be regarded as limiting the present disclosure. All other embodiments obtained from those skilled in the field without creative work may be within the protection scope of the present disclosure.

As previously mentioned, to improve the image enhancement effect of the U-shaped network, one implementation manner may be that the low-resolution feature search module may be embedded (added) after the encoding module and before the decoding module of the U-shaped network. In such way, the highly discriminative features needed for enhancement may be extracted from the minimum-resolution feature map outputted by the encoding module and then feed such highly discriminative features into the decoding module for decoding. Such low-resolution feature search module may employ a convolution module with a large kernel (convolution kernel), a nonlocal module, or a transformer module. Such modules may be computationally intensive; and when deployed, may encounter issues, such as softmax, levelnorm and the like which are difficult to be quantized, or slow computation at the terminal of a neural network processing unit (NPU).

To increase the processing speed of image enhancement and make deployment more user-friendly, the present disclosure provides an image enhancement solution.

An image enhancement method, an image enhancement apparatus, an image enhancement model, and a model training method provided in embodiments of the present disclosure may be configured in an electronic device; and the electronic device may include a processor capable of processing images, such as a CPU (central processing unit) or a GPU (graphics processing unit).

The electronic device may be a terminal device or a server. The server may be a single server, a server cluster, a cloud server or the like.

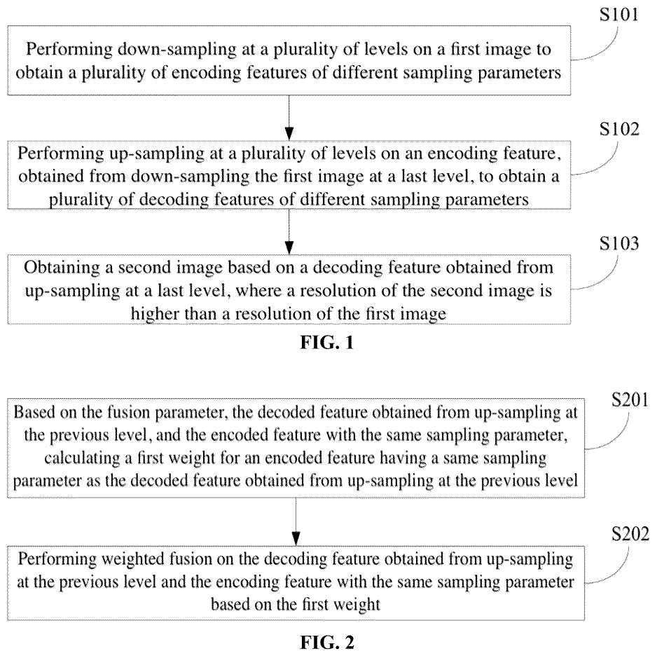

Referring to FIG. 1, FIG. 1 illustrates an implementation flowchart of an image enhancement method according to various embodiments of the present disclosure. The image enhancement method may include following exemplary steps.

At S101, down-sampling at a plurality of levels may be performed on the first image to obtain a plurality of encoding features with different sampling parameters.

The first image may be a lower-quality image to be enhanced. The first image may be an RGB image, a grayscale image, a depth image, or an image in another format; and the format of the first image may be not limited in the present disclosure. The first image may be an image obtained from an image acquisition device, an image edited by an image editor, or an AI-generated image.

The input of the first down-sampling level may be the first image. Starting from the second down-sampling level, the input of each down-sampling level may be the encoding feature obtained from previous down-sampling level. That is, the input of the first down-sampling level may be the first image, and the input of the i-th down-sampling level (i=2, 3, . . . , I; and I is total number of down-sampling levels) may be the encoding feature outputted from the (i−1)-th down-sampling level.

The sampling parameters of the encoding features may refer to the resolution or size of the encoding features. That is, down-sampling of the first image may be performed at the plurality of levels to obtain the plurality of encoding features of different resolutions, or the plurality of encoding features of different sizes.

The encoding feature obtained at each down-sampling level may be a feature map of the first image. Therefore, down-sampling at different levels may result in feature maps of the first image of different resolutions, or feature maps of the first image of different sizes. In the encoding features obtained at two adjacent down-sampling levels, the resolution or size of the encoding feature obtained at a later down-sampling level may be less than the resolution or size of the encoding feature obtained at a previous down-sampling level.

Optionally, down-sampling of the first image may be performed at the plurality of levels using any of following down-sampling manners, including max pooling, convolution, mean pooling and the like. The down-sampling manners used at different down-sampling levels may be same or different.

At S102, up-sampling at a plurality of levels may be performed on the encoding feature obtained at the last down-sampling level to obtain a plurality of decoding features with different sampling parameters.

In one embodiment, the input of the first up-sampling level may be the encoding feature outputted from the last down-sampling level. That is, the processing object of up-sampling at the first level may be the encoding feature obtained from down-sampling at the last level.

Up-sampling at each non-first level may include fusing the decoding feature obtained from up-sampling at previous level with the encoding feature of the same sampling parameter to obtain a fused feature and performing up-sampling on the fused feature. The process of obtaining the fused feature of at least one non-first level may include fusing the decoding feature obtained from up-sampling at previous level with the encoding feature of the same sampling parameter using a pre-learned fusion parameter.

For the decoding features obtained at two adjacent up-sampling levels, the resolution or size of the decoding feature obtained at a later up-sampling level may be greater than the resolution or size of the decoding feature obtained at previous up-sampling level.

In the present disclosure, the number of up-sampling levels may be same as the number of down-sampling levels, where the sampling parameter of the encoding feature obtained at the j-th (j=1, 2, 3, . . . , I−1) up-sampling level may be same as the sampling parameter of the encoding feature obtained at the (I−j)-th down-sampling level.

In the present disclosure, starting from the second up-sampling level, up-sampling may be not performed on the output of previous up-sampling level; instead, the decoding feature outputted from previous up-sampling level may be fused with the encoding feature of the same sampling parameter to obtain the fused feature, and up-sampling may be performed on the fused feature. When fusing the encoded feature and the decoding feature of the same sampling parameter, the fusion process corresponding to at least a part of up-sampling levels may be using the pre-learned fusion parameter to fuse the encoded feature and the decoding feature of the same sampling parameter. That is, the fusion process corresponding to only a part of up-sampling levels may use the pre-learned fusion parameter; or the fusion processes corresponding to (I−1) up-sampling levels may all use the pre-learned fusion parameter to fuse the encoded feature and the decoding feature of the same sampling parameter.

In response to that only a part of up-sampling levels uses the pre-learned fusion parameter, the fusion processes corresponding to other up-sampling levels may be directly adding the encoded feature and the decoding feature of the same sampling parameter.

Through above-mentioned multi-level up-sampling, the decoding feature obtained from the last up-sampling level may have strong discriminative feature needed for image enhancement.

Optionally, up-sampling at the plurality of levels may be performed on the encoding feature obtained from down-sampling at the last level using any of following up-sampling manners, including inverse max pooling, transposed convolution, inverse mean pooling and the like. Up-sampling manners used at different up-sampling levels may be same or different.

At S103, the second image may be obtained based on the decoding feature obtained from up-sampling at the last level. The resolution of the second image may be higher than the resolution of the first image. The content in the second image may be same as the content in the first image.

The decoding feature obtained from up-sampling at the last level may have the strong discriminative feature needed for image enhancement, which may ensure the quality of the second image to be higher than that of the first image.

The image enhancement method provided in the present disclosure may no longer use the low-resolution feature search module. Instead, after performing down-sampling on the lower-quality first image at the plurality of levels to obtain the plurality of encoding features with different sampling parameters, up-sampling at the plurality of levels may be performed on the encoding feature, obtained from down-sampling at the last level, to obtain the plurality of decoding features with different sampling parameters. Up-sampling at each non-first level may include fusing the decoding feature obtained from up-sampling at previous level with the encoding feature of the same sampling parameter to obtain a fused feature and performing up-sampling on the fused feature. The process of obtaining the fused feature of at least one non-first level may include fusing the decoding feature obtained from up-sampling at previous level with the encoding feature of the same sampling parameter using a pre-learned fusion parameter. In such way, when the features of sufficiently low-quality images are obtained, excessive low-quality features may not interfere with the generation of the high-quality images, which may ensure that the decoding feature obtained from up-sampling at the last level may have the strong discriminative power needed for enhancement. Furthermore, the process of fusing the encoding feature and the decoding feature of the same sampling parameter may not require complex computations, thereby minimizing computational effort, ensuring the processing speed for image enhancement and facilitating easy deployment.

In an optional embodiment, FIG. 2 illustrates an implementation flowchart of fusing the decoding feature obtained from up-sampling at previous level with the encoding feature of the same sampling parameter using the pre-learned fusion parameter according to various embodiments of the present disclosure, which may include following exemplary steps.

At S201, based on the fusion parameter, the decoding feature obtained from up-sampling at previous level, and the encoding feature of the same sampling parameter, the first weight of the encoding feature which has same sampling parameter as the decoding feature obtained from up-sampling at previous level may be calculated.

The first weight may be calculated as follows: calculating the global feature score g: g=sigmoid(Down-sample_r(e+d)*W); and calculating the gated feature score s: s=sigmoid(Up-sample_r(g)).

Down-sample_r denotes a down-sampling operation using a window size of r; and such operation may be implemented by manners such as max pooling, convolution, average pooling or the like.

Up-sample_r denotes an up-sampling operation using a window size of r; and such operation may be implemented by manners such as inverse max pooling (maxUnPooling), transposed convolution, inverse mean pooling (averageUnpooling) or the like.

Sigmoid( ) is a threshold function configured to map the variables in the bracket to the range [0, 1].

e denotes an encoding feature, and d denotes a decoding feature. e and d may have same sampling parameter. That is, d denotes the decoding feature obtained from up-sampling at previous level, and e denotes the encoding feature of the same sampling parameter as d.

W denotes a pre-learned fusion parameter, which is a matrix with dimensions h/r*w/r, where h denotes a height of the encoding feature e, and w denotes a width of the encoding feature e. The height and the width of the decoding feature d may be same as the height and the width of the encoding feature e.

The gated feature score s may be the first weight of the encoding feature e.

At S202, weighted fusion may be performed on the decoding feature obtained from up-sampling at previous level and the encoding feature of the same sampling parameter based on the first weight.

After obtaining the first weight s of the encoding feature e, the first weight s may be configured to perform weighted fusion of the decoding feature d obtained from up-sampling at previous level and the encoding feature e of the same sampling parameter.

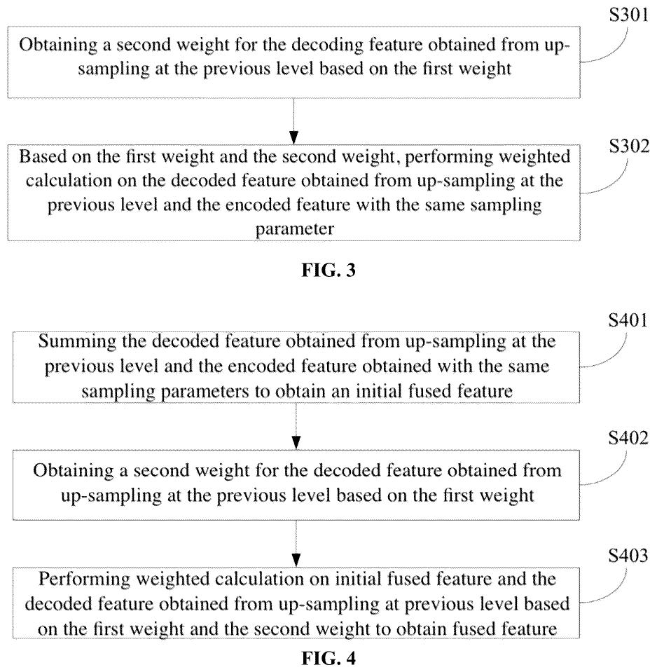

In an optional embodiment, FIG. 3 illustrates an implementation flowchart of weighted fusing the decoding feature obtained from up-sampling at previous level with the encoding feature of the same sampling parameter based on the first weight according to various embodiments of the present disclosure, which may include following exemplary steps.

At S301, the second weight of the decoding feature obtained from up-sampling at previous level may be obtained based on the first weight.

Optionally, the second weight may be the difference between 1 and the first weight; that is, the second weight may be 1-s.

At S302, weighted calculation may be performed on the decoding feature obtained from up-sampling at previous level and the encoding feature of the same sampling parameter based on the first weight and the second weight to obtain the fused feature.

In one embodiment, the fused feature f may be calculated as follows: f=s*e+(1−s)*d.

In an optional embodiment, FIG. 4 illustrates another implementation flowchart of weighted fusing the decoding feature obtained from up-sampling at previous level with the encoding feature of the same sampling parameter based on the first weight according to various embodiments of the present disclosure. Referring to FIG. 4, the image enhancement method may include following exemplary steps.

At S401, the decoding feature obtained from up-sampling at previous level and the encoding feature of the same sampling parameter may be summed to obtain an initial fused feature.

That is, the initial fused feature may be e+d.

At S402, the second weight of the decoding feature obtained from up-sampling at previous level may be obtained based on the first weight.

Optionally, the second weight may be the difference between 1 and the first weight; that is, the second weight may be 1-s.

In the present disclosure, exemplary step S401 may be executed first, and then exemplary step S402 may be executed; or exemplary step S402 may be executed first and then exemplary step S401 may be executed; or both exemplary steps may be executed simultaneously. The present disclosure may not limit the execution order of above-mentioned two exemplary steps.

At S403, weighted calculation may be performed on the initial fused feature and the decoding feature obtained from up-sampling at previous level based on the first weight and the second weight to obtain the fused feature.

In one embodiment, the fused feature f may be calculated as follows: f=s*(e+d)+(1−s)*d.

In an optional embodiment, above-mentioned process of performing down-sampling at the plurality of levels on the first image, performing up-sampling at the plurality of levels on the encoding feature obtained from the down-sampling at the last level, and obtaining the second image based on the decoding feature obtained from up-sampling at the last level may be implemented using a pre-trained enhancement network (also referred to as an image enhancement model), which is described in detail hereinafter.

Down-sampling at the plurality of levels may be performed on the first image using the first encoding module of the enhancement network.

Up-sampling at the plurality of levels may be performed on the encoding feature obtained from the down-sampling at the last level using the decoding module of the enhancement network. Up-sampling at each non-first level may include obtaining the fused feature by fusing the decoding feature obtained from up-sampling at previous level with the encoding feature of the same sampling parameter through the fusion module of the enhancement network and performing up-sampling on the fused feature. The process of obtaining the fused feature for at least one non-first level may include fusing, by the fusion module, the decoding feature obtained from up-sampling at previous level with the encoding feature of the same sampling parameter using the pre-learned fusion parameter.

The decoding feature obtained from up-sampling at the last level may be processed to obtain the second image using the output module of the enhancement network.

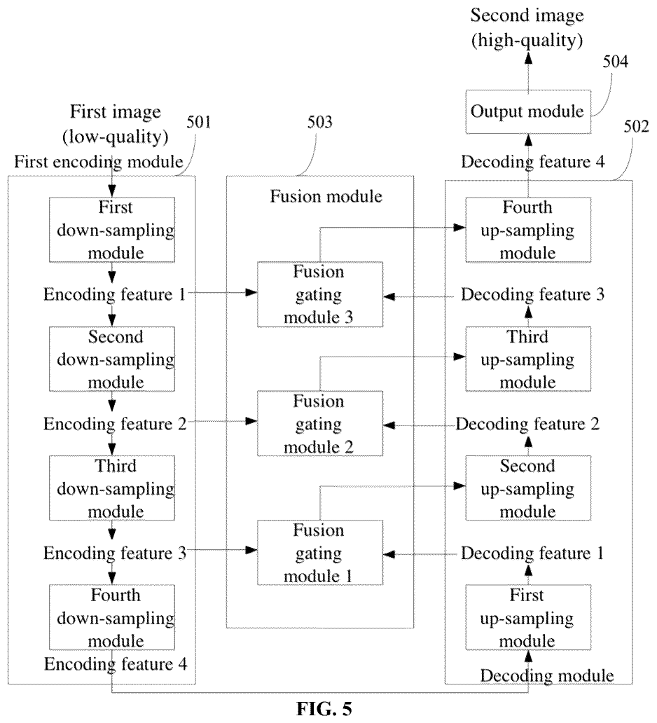

FIG. 5 illustrates a structural schematic of an enhancement network according to various embodiments of the present disclosure.

The enhancement network may include an encoding module 501 (referred to as the first encoding module for ease of description), a decoding module 502, a fusion module 503, and an output module 504.

The first encoding module 501 may be configured to perform down-sampling at the plurality of levels on the first image to obtain the plurality of encoding features with different sampling parameters.

In one embodiment shown in FIG. 5, the first encoding module 501 may perform down-sampling at four levels on the first image. In practical applications, the first encoding module 501 may perform down-sampling at more levels, or at three or two levels. The number of down-sampling levels may be not limited at various embodiments of the present disclosure.

The decoding module 502 may be configured to perform up-sampling at the plurality of levels on the encoding feature obtained from down-sampling at the last level (e.g., the encoding feature 4 in FIG. 5) to obtain the plurality of decoding features with different sampling parameters. Up-sampling at each non-first level may include obtaining the fused feature by fusing the decoding feature obtained from up-sampling at previous level with the encoding feature of the same sampling parameter by the fusion module 503 and performing up-sampling on the fused feature. The process of obtaining the fused feature for at least one non-first level may include fusing, by the fusion module 503, the decoding feature obtained from up-sampling at previous level with the encoding feature of the same sampling parameter using the pre-learned fusion parameter.

In one embodiment shown in FIG. 5, the decoding module 502 may perform up-sampling at four levels on the encoding feature obtained from down-sampling at the last level. In practical applications, decoding module 502 may have more levels of up-sampling or have three or two levels of up-sampling. The number of up-sampling levels may be not limited, which may only need to satisfy that the number of up-sampling levels is same as the number of down-sampling levels.

In the fusion module, the fusion parameters in different fusion gating modules may be same or different, and actual values may be determined based on the training of the enhancement network.

The output module 504 may be configured to generate the second image based on the decoding feature obtained from up-sampling at the last level (e.g., the decoding feature 4 in FIG. 5); and the resolution of the second image may be higher than the resolution of the first image.

In one embodiment shown in FIG. 5, the fusion module may be configured to fuse the encoding features and the decoding features of the same sampling parameters at three levels based on the fusion parameters. In other embodiments, the fusion module may be configured to only fuse the encoding features and the decoding features of the same sampling parameters at two levels; or only fuse the encoding feature and the decoding feature of the same sampling parameter at one level.

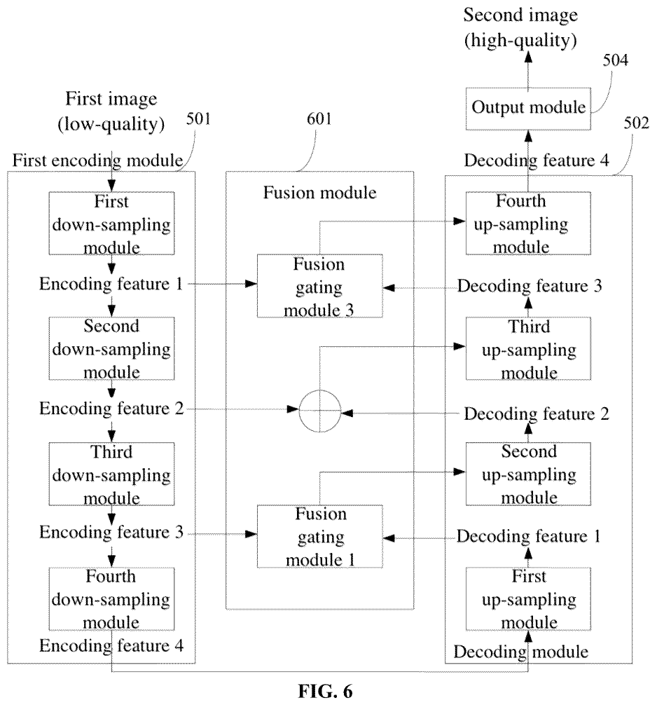

FIG. 6 illustrates another structural schematic of the enhancement network according to various embodiments of the present disclosure. The structures of the first encoding module, the decoding module, and the output module in one embodiment shown in FIG. 6 may be same as the structures of the first encoding module, the decoding module, and the output module in one embodiment shown in FIG. 5; and the difference may only be that the structures of the fusion modules may be different. In one embodiment shown in FIG. 6, the fusion module 601 may be configured to only fuse the encoding features and the decoding features of the same sampling parameters at two levels based on the fusion parameters (the encoding feature 1 and the decoding feature 3 may be only fused based on the fusion parameter learned by the fusion gating module 3; and the encoding feature 3 and the decoding feature 1 may be only fused based on the fusion parameter learned by the fusion gating module 1); and the encoding feature and the decoding feature of the same sampling parameter at another level may be not fused based on the learned fusion parameter but may be simply fused by addition (i.e., the encoding feature 2 and the decoding feature 2 may be directly fused by an addition manner).

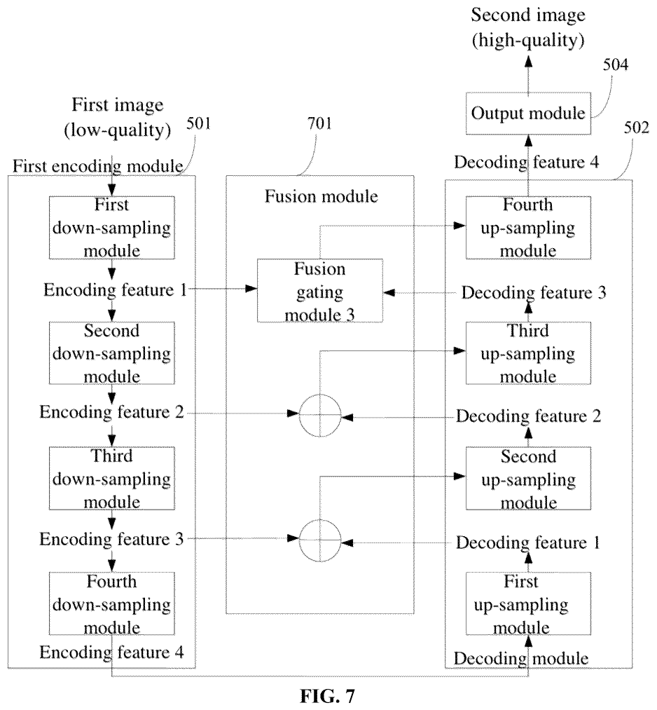

FIG. 7 illustrates another structural schematic of the enhancement network according to various embodiments of the present disclosure. The structures of the first encoding module, the decoding module, and the output module in one embodiment shown in FIG. 7 may be same as the structures of the first encoding module, the decoding module, and the output module in one embodiment shown in FIG. 5; and the difference may only be that the structures of the fusion modules may be different. In one embodiment shown in FIG. 7, the fusion module 701 may be configured to only fuse the encoding feature and the decoding feature of the same sampling parameter at one level based on the fusion parameter (the encoding feature 1 and the decoding feature 3 may be only fused based on the fusion parameter learned by the fusion gating module 3); and the encoding features and the decoding features of the same sampling parameters at another two levels may be not fused based on the learned fusion parameters but may be simply fused by addition (i.e., the encoding feature 2 and the decoding feature 2 may be directly fused by an addition manner, and the encoding feature 3 and the decoding feature 1 may be directly fused by an addition manner).

In an optional embodiment, when the fusion module fuses the decoding feature obtained from up-sampling at previous level and the encoding feature of the same sampling parameter using the pre-learned fusion parameter, the fusion module may be configured to, based on the fusion parameter, the decoding feature obtained from up-sampling at previous level and the encoding feature of the same sampling parameter, calculate the first weight of the encoding feature which has same sampling parameter as the decoding feature obtained from up-sampling at previous level, which may refer to above-mentioned embodiments for implementation manners and may be not described in detail herein.

Weighted fusion may be performed on the decoding feature obtained from up-sampling at previous level and the encoding feature of the same sampling parameter based on the first weight, which may refer to above-mentioned embodiments for implementation manners and may be not described in detail herein.

In the fusion module, each fusion gating module may fuse inputted encoding feature and inputted decoding feature, which have same sampling parameter, based on the learned fusion parameter. For example, the fusion gating module 1 may fuse the encoding feature 3 and the decoding feature 1 based on the first fusion parameter learned; the fusion gating module 2 may fuse the encoding feature 2 and the decoding feature 2 based on the second fusion parameter learned; and the fusion gating module 3 may fuse the encoding feature 1 and the decoding feature 3 based on the third fusion parameter learned.

In FIGS. 5-7, the process of each fusion module fusing the encoding features and the decoding features of the same sampling parameters based on learned fusion parameters may be referred to above-mentioned embodiments and may be not described in detail herein.

In an optional embodiment, the enhancement network may may be obtained from a training manner: performing unsupervised training on the initial network obtained (generated) from the second encoding module, the decoding module 502, and the output module 504 using high-quality images from the first image set to obtain a pre-trained network.

The first image set may include the plurality of low-quality images (with lower resolution) and high-quality images (with higher resolution) corresponding to the plurality of low-quality images. The second encoding module may be configured to perform down-sampling at the plurality of levels on the high-quality images inputted to obtain the plurality of encoding features with different sampling parameters. Among the plurality of encoding features with different sampling parameters obtained from the second encoding module, at least one encoding feature may have same sampling parameter as at least one encoding feature in the plurality of encoding features with different sampling parameters, which is obtained from down-sampling at the plurality of levels on the high-quality images inputted.

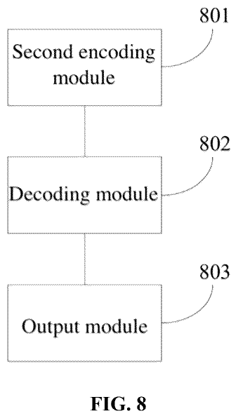

FIG. 8 illustrates a structural schematic of an initial network according to various embodiments of the present disclosure. The initial network may include a second encoding module 801, a decoding module 802, and an output module 803. The structures of the second encoding module 801 and the first encoding module 501 may be same or different, which may only need to satisfy that the second encoding module 801 may perform down-sampling at the plurality of levels on inputted image and obtain the encoding feature of the same sampling parameter as at least one encoding feature outputted by the first encoding module 501. The structures of the decoding module 802 and the decoding module 502 may be same; and the structures of the output module 803 and the output module 504 may be same.

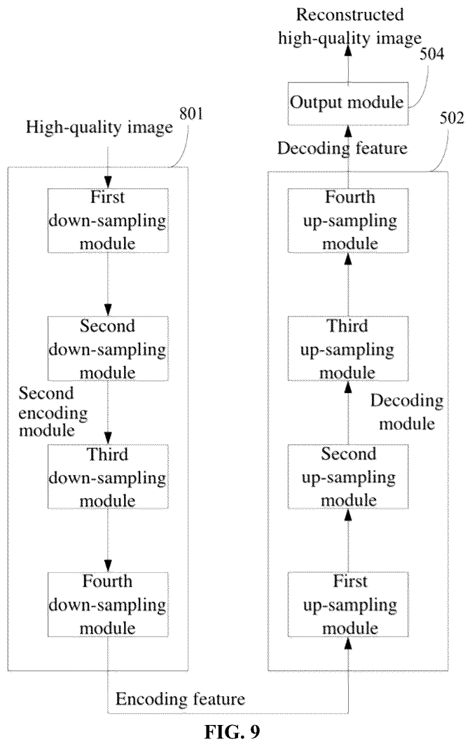

FIG. 9 illustrates another structural schematic of the initial network according to various embodiments of the present disclosure. In one embodiment, the structures of the second encoding module 801 and the first encoding module 501 may be same; and the second encoding module 801 and the first encoding module 501 may both include four down-sampling modules.

An implementation manner of unsupervised training of the initial network is described hereinafter.

The high-quality image may be inputted into the second encoding module 801.

The second encoding module 801 may perform down-sampling at the plurality of levels on the high-quality image to obtain the plurality of encoding features with different sampling parameters.

The decoding module 502 may perform up-sampling at the plurality of levels on the encoding feature obtained from the down-sampling at the last level of the second encoding module 801 to obtain the plurality of decoding features with different sampling parameters.

The output module 504 may process the decoding feature obtained from up-sampling at the last level of the decoding module 502 to obtain reconstructed high-quality image.

For example, the parameters of the initial network may be updated with the goal of minimizing the difference between reconstructed high-quality image and original high-quality image (i.e., compared with the reconstructed image obtained by reconstructing the high-quality image using the initial network before the parameters are updated, the reconstructed image obtained by reconstructing the high-quality image using the initial network after the parameters are updated may be closer to original high-quality image).

The purpose of unsupervised training of the initial network using high-quality images may be to fully utilize the characteristics of the high-quality images to obtain desirable decoding module, such that the enhanced images may be more realistic.

After obtaining the pre-trained network, supervised training may be performed on the first encoding module (the first encoding module herein may or may not be the second encoding module in the pre-trained network) and the fusion module based on the pre-trained network using the first image set, thereby obtaining the first encoding module and the fusion module trained. The first encoding module and the fusion module trained, along with the decoding module and the output module in the pre-trained network, may form the enhancement network, that is, the image enhancement model.

Optionally, in response to that the structure of the second encoding module is the same as the structure of the first encoding module, supervised training may be performed on the fusion module and the second encoding module in the pre-trained network using the first image set based on the pre-trained network, thereby obtaining the fusion module and the first encoding module trained (i.e., the trained second encoding module may be configured as the first encoding module).

In response to that the structure of the second encoding module is different from the structure of the first encoding module, supervised training may be performed on the first encoding module and the fusion module using the first image set based on the pre-trained network, thereby obtaining the first encoding module and the fusion module trained.

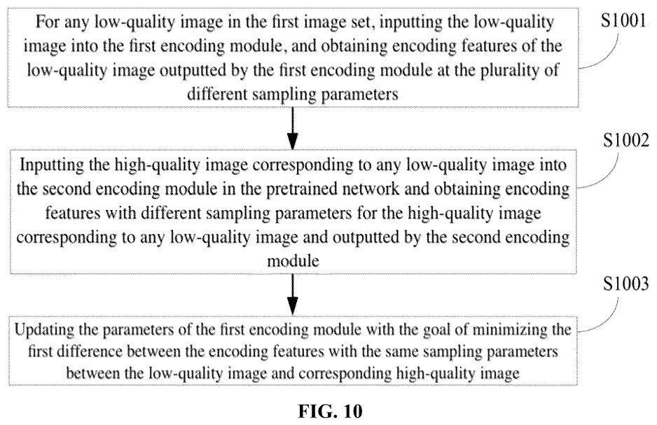

In an optional embodiment, FIG. 10 illustrates an implementation flowchart of performing supervised training on the first encoding module using the first image set based on the pre-trained network according to various embodiments of the present disclosure, which may include following exemplary steps.

At S1001, for any low-quality image in the first image set, any low-quality image may be inputted into the first encoding module to obtain the plurality of encoding features, with different sampling parameters, of any low-quality image outputted by the first encoding module.

The first encoding module herein may be the second encoding module in the pre-trained network, or an encoding module different from the second encoding module in the pre-trained network.

At S1002, the high-quality image corresponding to any low-quality image may be inputted into the second encoding module in the pre-trained network to obtain the plurality of encoding features, with different sampling parameters, of the high-quality image corresponding to any low-quality image and outputted by the second encoding module.

In response to that the first encoding module is the second encoding module in the pretrained network, the sampling parameters of the encoding features outputted by the second encoding module and the first encoding module in such exemplary step may be all same.

In response to that the first encoding module is not the second encoding module in the pretrained network, the following possibilities may exist.

The sampling parameters of the encoding features outputted by the second encoding module and the first encoding module may be all same.

A part of the encoding features outputted by the second encoding module may have same sampling parameters as at least a part of the encoding features outputted by the first encoding module.

The encoding features outputted by the second encoding module may have same sampling parameters as a part of the encoding features outputted by the first encoding module.

At S1003, the parameters of the first encoding module may be updated with the goal of minimizing the first difference between the encoding features of the low-quality image and the encoding features of corresponding high-quality image of the same sampling parameter.

In other words, any low-quality image may be encoded using the first encoding module before the parameters are updated, and the plurality of encoding features with different sampling parameters may be obtained from down-sampling at the plurality of levels on the low-quality image using the first encoding module after the parameters are updated; and compared with the encoding features of the low-quality image, the encoding features, of the same sampling parameter, obtained from down-sampling at the plurality of levels on the high-quality image corresponding to the low-quality image using the second encoding module may have a smaller first difference.

In one embodiment, the second encoding module in the pre-trained network may be configured as the teacher network; and the first encoding module may be configured as the student network to perform distillation training on the first encoding module, such that the features obtained from the student network may be closer to the features obtained from the teacher network.

In an optional embodiment, for the first coding feature of any sampling parameter of any low-quality image and the second coding feature of any sampling parameter of the high-quality image corresponding to any low-quality image (i.e., the second coding feature and the first coding feature may be coding features of different images of the same sampling parameter), the first difference between the first coding feature and the second coding feature may be calculated hereinafter.

The absolute error between the first coding feature and the second coding feature (denoted as Loss1), the sum squared error between the first classification result obtained based on the first coding feature and the second classification result obtained based on the second coding feature (denoted as Loss2), and the maximum output error between the first coding feature and the second coding feature (denoted as Loss3) may be obtained.

Optionally, above-mentioned three errors above may be calculated as follows:

$$Loss 1 = {\vert f ( teacher ) - f ( student ) \vert}_{1} ;$$

$$Loss 2 = {\vert vgg ( f ( teacher ) ) - vgg ( f ( student ) ) \vert}_{2} ; and$$

$$Loss 3 = {\vert softmax ( f ( teacher ) \times f ( teacher ) . T ) - softmax ( f ( student ) \times f ( student ) . T ) \vert}_{2} .$$

where f(teacher) denotes the second encoding feature, and f (student) denotes the first encoding feature. vgg denotes the pre-trained vgg network for image classification. vgg(f(teacher)) denotes the second classification result obtained from the vgg network based on the second encoding feature, and vgg(f(student)) denotes the first classification result obtained from the vgg network based on the first encoding feature. f(teacher).T denotes the transposed matrix of the second encoding feature; and f(student).T denotes the transposed matrix of the first encoding feature.

The weighted sum of the absolute error, the sum squared error, and the maximum output error may be configured to obtain the first difference (denoted as Loss) between the first encoding feature and the second encoding feature.

The first difference Loss may be calculated as follows:

$$Loss = λ1 \times Loss 1 + λ2 \times Loss 2 + λ3 \times Loss 3$$

Where λ1, λ2, and λ3 are the weights of three errors. Above-mentioned weights may be hyperparameters, that is, pre-set.

Optionally, the weight of the absolute error may be negatively correlated with the down-sampling level used to obtain the first encoding feature. That is, the lower the down-sampling level is, the greater corresponding absolute error weight is. Correspondingly, the larger the size (or resolution) of the first encoding feature is, the greater corresponding absolute error weight is.

Optionally, the weight of the sum squared error may be positively correlated with the down-sampling level of the first encoding feature. That is, the higher the down-sampling level is, the greater corresponding sum squared error weight is. Correspondingly, the smaller the size (or resolution) of the first encoding feature is, the greater corresponding sum squared error weight is.

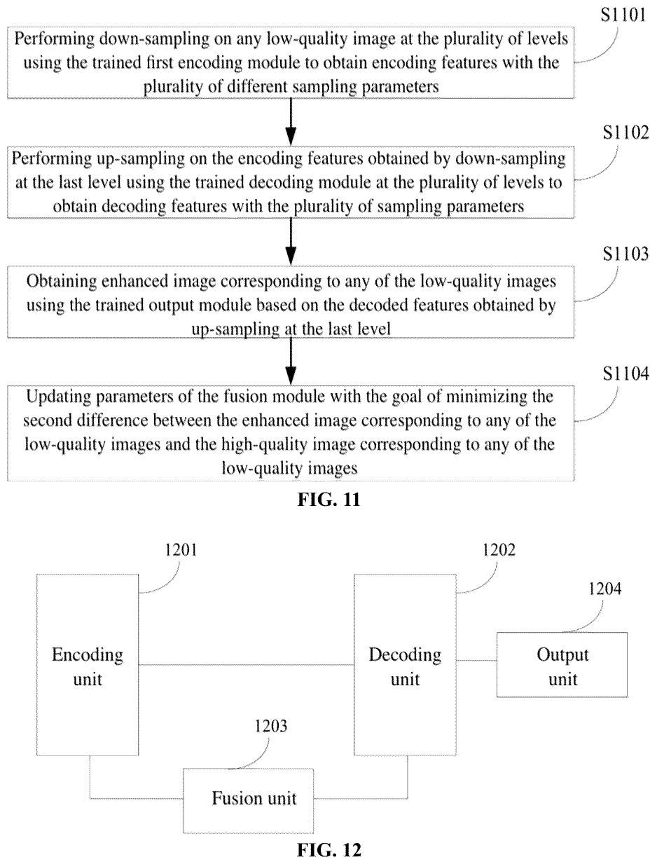

In an optional embodiment, after the first encoding feature is trained, FIG. 11 illustrates an implementation flowchart of performing supervised training on the fusion module using the first image set based on the pre-trained network according to various embodiments of the present disclosure, which may include following exemplary steps.

At S1101, down-sampling at the plurality of levels may be performed on any low-quality image using trained first encoding module to obtain the plurality of encoding features with different sampling parameters.

The trained first encoding module may refer to the first encoding module obtained through above-mentioned distillation training.

At S1102, up-sampling at the plurality of levels may be performed on the encoding features obtained from down-sampling at the last level using the trained decoding module to obtain the plurality of decoding features with sampling parameters. Up-sampling at each non-first level may include obtaining the fused feature from the fusion module by fusing the decoding feature obtained from up-sampling at previous level with the encoding feature of the same sampling parameter and performing up-sampling on the fused feature. The process of obtaining the fused feature of at least one non-first level may include fusing, by the fusion module, the decoding feature obtained from up-sampling at previous level with the encoding feature of the same sampling parameter using the fusion parameter.

The process of obtaining the fused feature by the fusion module may refer to above-mentioned embodiments and may be not described in detail herein.

The trained decoding module may refer to the decoding module in the pre-trained network obtained by training the initial network.

At S1103, an enhanced image corresponding to any low-quality image may be obtained using the trained output module based on the decoding feature obtained from up-sampling at the last level.

The trained output module may refer to the output module in the pre-trained network obtained by training the initial network.

At S1104, the parameters of the fusion module may be updated with the goal of minimizing the second difference between the enhanced image corresponding to any low-quality image and the high-quality image corresponding to any low-quality image.

The parameters of the fusion module may include above-mentioned fusion parameters.

The second difference between the enhanced image corresponding to any low-quality image and the high-quality image corresponding to the low-quality image described above may be minimized, which indicates that compared to image enhancement performed on any low-quality image using the fusion module before the parameters are updated, the enhanced image obtained from image enhancement of any low-quality image using the fusion module after the parameters are updated may be closer to the high-quality image corresponding to the low-quality image.

When the fusion module is trained, the parameters of the first encoding module, the decoding module, and the output module may be frozen and remain unchanged.

Corresponding to method embodiments, the present disclosure further provides an image enhancement device. FIG. 12 illustrates a structural schematic of an image enhancement device according to various embodiments of the present disclosure. Referring to FIG. 12, the image enhancement device may include an encoding unit 1201, a decoding unit 1202, a fusion unit 1203, and an output unit 1204.

The encoding unit 1201 may be configured to perform down-sampling at the plurality of levels on the first image to obtain the plurality of encoding features with different sampling parameters.

The decoding unit 1202 may be configured to perform up-sampling at the plurality of levels on the encoding feature obtained from down-sampling the last level to obtain the plurality of decoding features with different sampling parameters. Up-sampling at each non-first level may include obtaining the fused feature from the fusion unit 1203 by fusing the decoding feature obtained from up-sampling at previous level with the encoding feature of the same sampling parameter and performing up-sampling on the fused feature. The process of obtaining the fused feature of at least one non-first level may include fusing, by the fusion module, the decoding feature obtained from up-sampling at previous level with the encoding feature of the same sampling parameter using the fusion parameter.

The output unit 1204 may be configured to obtain the second image based on the decoding feature obtained from up-sampling at the last level; and the resolution of the second image may be higher than the resolution of the first image.

The image enhancement device provided in embodiment of the present disclosure may perform down-sampling at the plurality of levels on the first image of relatively low resolution to obtain the plurality of encoding features with different sampling parameters; and perform up-sampling at the plurality of levels on the encoding feature obtained from down-sampling the last level to obtain the plurality of decoding features with different sampling parameters. Up-sampling at each non-first level may include obtaining the fused feature by fusing the decoding feature obtained from up-sampling at previous level with the encoding feature of the same sampling parameter and performing up-sampling on the fused feature. The process of obtaining the fused feature of at least one non-first level may include fusing, by the fusion module, the decoding feature obtained from up-sampling at previous level with the encoding feature of the same sampling parameter using the pre-trained fusion parameter. The image enhancement device may further obtain the second image of relatively high resolution based on the decoding feature obtained from up-sampling at the last level. The decoding features and the encoding features of the same sampling parameters may be fused using pre-learned fusion parameters, and up-sampling may be performed, such that the generation of high-quality images may not be interfered by excessive low-quality features when sufficiently low-quality image features are obtained. Therefore, the decoding feature obtained from the last up-sampling level may have the strong discriminative features needed for enhancement. Furthermore, the feature fusion process may not require complex computations, which may minimize the computational complexity of the image enhancement process and ensure high processing speed and ease of deployment.

In an optional embodiment, when fusing the decoding feature obtained from up-sampling at previous level and the encoding feature of the same sampling parameter using the pre-learned fusion parameter, the fusion unit 1203 may be configured to, based on the fusion parameter, the decoding feature obtained from up-sampling at previous level and the encoding feature of the same sampling parameter, calculate the first weight of the encoding feature which has same sampling parameter as the decoding feature obtained from up-sampling at previous level; and perform weighted fusion on the decoding feature obtained from up-sampling at previous level and the encoding feature of the same sampling parameter based on the first weight.

In an optional embodiment, when the fusion unit 1203 performs weighted fusion on the decoding feature obtained from up-sampling at previous level and the encoding feature of the same sampling parameter based on the first weight, the fusion unit 1203 may be configured to obtain the second weight of the decoding feature obtained from up-sampling at previous level based on the first weight; and perform weighted calculation on the decoding feature obtained from up-sampling at previous level and the encoding feature of the same sampling parameter based on the first weight and the second weight.

In an optional embodiment, when the fusion unit 1203 performs weighted fusion on the decoding feature obtained from up-sampling at previous level and the encoding feature of the same sampling parameter based on the first weight, the fusion unit 1203 may be configured to sum the decoding feature obtained from up-sampling at previous level and the encoding feature of the same sampling parameter to obtain an initial fused feature; obtain the second weight of the decoding feature obtained from up-sampling at previous level based on the first weight; and perform weighted calculation on the initial fused feature and the decoding feature obtained from up-sampling at previous level based on the first weight and the second weight.

In an optional embodiment, the image enhancement device may perform down-sampling at the plurality of levels on the first image, perform up-sampling at the plurality of levels on the encoding feature obtained from the down-sampling at the last level, and obtain the second image based on the decoding feature obtained from up-sampling at the last level, which is described in detail hereinafter.

The image enhancement device may perform down-sampling at the plurality of levels on the first image using the first encoding module of the enhancement network; and perform up-sampling at the plurality of levels on the encoding feature obtained from down-sampling the last level to obtain the plurality of decoding features with different sampling parameters using the decoding module of the enhancement network. Up-sampling at each non-first level may include obtaining the fused feature from the fusion module of the enhancement network by fusing the decoding feature obtained from up-sampling at previous level with the encoding feature of the same sampling parameter and performing up-sampling on the fused feature. The process of obtaining the fused feature of at least one non-first level may include fusing, by the fusion module, the decoding feature obtained from up-sampling at previous level with the encoding feature of the same sampling parameter using the pre-learned fusion parameter. The image enhancement device may further process the decoding feature obtained from up-sampling at the last level by the output module of the enhancement network to obtain the second image.

In an optional embodiment, the enhancement network may be obtained from a training manner described below.

Unsupervised training may be performed on the initial network generated by the second encoding module, the decoding module, and the output module using high-quality images from the first image set to obtain the pre-trained network. The first image set may include the plurality of low-quality images and high-quality images corresponding to all low-quality images. The second encoding module may be configured to perform down-sampling at the plurality of levels on inputted high-quality images to obtain the plurality of encoding features with different sampling parameters.

Based on the pre-trained network, supervised training may be performed on the first encoding module and the fusion module using the first image set to obtain the trained first encoding module and the trained fusion module. The trained first encoding module and the trained fusion module, along with the decoding module and the output module in the pre-trained network may form the enhancement network.

The implementation manner of the enhancement network (device or method) may refer to above-mentioned embodiments and may be not described in detail herein.

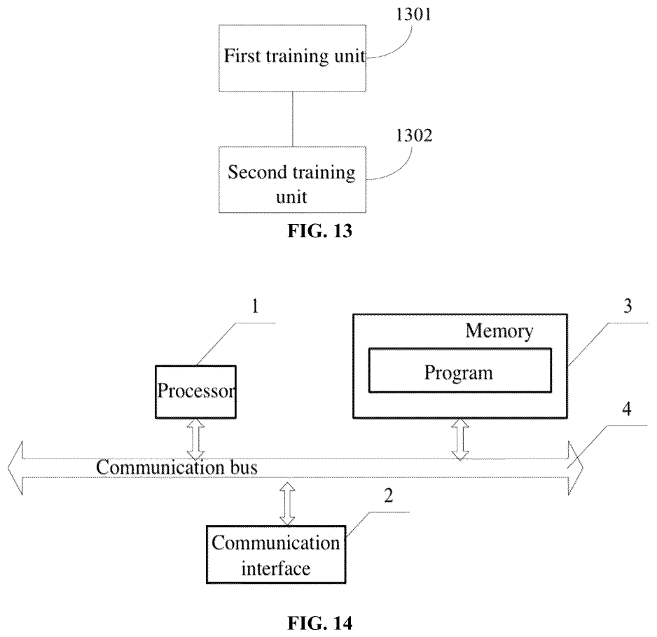

Corresponding to method embodiments, the present disclosure further provides a model training device for training above-mentioned image enhancement model. FIG. 13 illustrates a structural schematic of a model training device according to various embodiments of the present disclosure. Referring to FIG. 13, the model training device may include the first training unit 1301 and the second training unit 1302.

The first training unit 1301 may be configured to perform unsupervised training on the initial network obtained from the second encoding module, the decoding module, and the output module using high-quality images from the first image set to obtain the pre-trained network. The first image set may include the plurality of low-quality images and high-quality images corresponding to all low-quality images. The second encoding module may be configured to perform down-sampling at the plurality of-level on the inputted high-quality image to obtain the plurality of encoding features with different sampling parameters. The structure of the second encoding module may be same as or different from the structure of the first encoding module.

The second training unit 1302 may be configured to perform supervised training on the first encoding module and the fusion module based on the pre-trained network using the first image set to obtain the trained first encoding module and the trained fusion module. The trained first encoding module and the trained fusion module, along with the decoding module and the output module in the pre-trained network, may form the enhancement network.

In an optional embodiment, when the second training unit 1302 performs supervised training on the first encoding module using the first image set based on the pre-trained network, the second training unit 1302 may be configured to: for any low-quality image in the first image set, input any low-quality image into the first encoding module to obtain the plurality of encoding features with different sampling parameters for any low-quality image; input the high-quality image corresponding to any low-quality image into the second encoding module in the pre-trained network to obtain the plurality of encoding features with different sampling parameters for the high-quality image corresponding to any low-quality image; and update the parameters of the first encoding module with the goal of minimizing the first difference in encoding features between the low-quality image and corresponding high-quality image of the same sampling parameter.

The implementation manner of the model training device may refer to above-mentioned embodiments and may be not described in detail herein.

Corresponding to method embodiments, the present disclosure further provides an electronic device. FIG. 14 illustrates a structural schematic of an electronic device according to various embodiments of the present disclosure. Referring to FIG. 14, the electronic device may include at least one processor 1, at least one communication interface 2, at least one memory 3, and at least one communication bus 4.

In embodiments of the present disclosure, the quantity of each of the processor 1, the communication interface 2, the memory 3, and the communication bus 4 may be at least one; and the processor 1, the communication interface 2, and the memory 3 may communicate with each other via the communication bus 4.

The processor 1 may be a central processing unit (CPU), an application-specific integrated circuit (ASIC), or one or more integrated circuits configured to implement embodiments of the present disclosure.

The memory 3 may include high-speed RAM, non-volatile memory or the like, such as at least one disk drive.

The memory 3 may store a program, and the processor 1 may call the program stored in the memory 3.

The program may be configured to perform down-sampling at the plurality of levels on the first image to obtain the plurality of encoding features with different sampling parameters; and perform up-sampling at the plurality of levels may be performed on the encoding feature obtained at the last down-sampling level to obtain the plurality of decoding features with different sampling parameters. Up-sampling at each non-first level may include fusing the decoding feature obtained from up-sampling at previous level with the encoding feature of the same sampling parameter to obtain the fused feature and performing up-sampling on the fused feature. The process of obtaining the fused feature of at least one non-first level may include fusing the decoding feature obtained from up-sampling at previous level with the encoding feature of the same sampling parameter using a pre-learned fusion parameter. The program may be further configured to obtain the second image based on the decoding feature obtained from up-sampling at the last level. The resolution of the second image may be higher than the resolution of the first image.

Or the program may be configured to perform unsupervised training on the initial network obtained from the second encoding module, the decoding module, and the output module using high-quality images from the first image set to obtain the pre-trained network. The first image set may include the plurality of low-quality images and high-quality images corresponding to all low-quality images. The second encoding module may be configured to perform down-sampling at the plurality of-level on the inputted high-quality image to obtain the plurality of encoding features with different sampling parameters. The program may be further configured to perform supervised training on the first encoding module and the fusion module based on the pre-trained network using the first image set to obtain the trained first encoding module and the trained fusion module. The trained first encoding module and the trained fusion module, along with the decoding module and the output module in the pre-trained network, may form the enhancement network.

Optionally, detailed and extended functions of the program may refer to above-mentioned description.

The present disclosure further provides a storage medium. The storage medium may store a program suitable for execution by a processor.

The program may be configured to perform down-sampling at the plurality of levels on the first image to obtain the plurality of encoding features with different sampling parameters; and perform up-sampling at the plurality of levels may be performed on the encoding feature obtained at the last down-sampling level to obtain the plurality of decoding features with different sampling parameters. Up-sampling at each non-first level may include fusing the decoding feature obtained from up-sampling at previous level with the encoding feature of the same sampling parameter to obtain the fused feature and performing up-sampling on the fused feature. The process of obtaining the fused feature of at least one non-first level may include fusing the decoding feature obtained from up-sampling at previous level with the encoding feature of the same sampling parameter using a pre-learned fusion parameter. The program may be further configured to obtain the second image based on the decoding feature obtained from up-sampling at the last level. The resolution of the second image may be higher than the resolution of the first image.

Or the program may be configured to perform unsupervised training on the initial network obtained from the second encoding module, the decoding module, and the output module using high-quality images from the first image set to obtain the pre-trained network. The first image set may include the plurality of low-quality images and high-quality images corresponding to all low-quality images. The second encoding module may be configured to perform down-sampling at the plurality of-level on the inputted high-quality image to obtain the plurality of encoding features with different sampling parameters. The program may be further configured to perform supervised training on the first encoding module and the fusion module based on the pre-trained network using the first image set to obtain the trained first encoding module and the trained fusion module. The trained first encoding module and the trained fusion module, along with the decoding module and the output module in the pre-trained network, may form the enhancement network.

Optionally, detailed and extended functions of the program may refer to above-mentioned description.

Various embodiments of the present disclosure provide an electronic device. The electronic device includes a memory, configured to store a computer program; and one or more processors, configured to, when the computer program is executed, perform an image enhancement method. The image enhancement method includes performing down-sampling at a plurality of levels on a first image to obtain a plurality of encoding features with different sampling parameters; performing up-sampling at a plurality of levels on an encoding feature, obtained from down-sampling at a last level, to obtain a plurality of decoding features with different sampling parameters; and obtaining a second image based on a decoding feature obtained from up-sampling at a last level, where a resolution of the second image is higher than a resolution of the first image. Up-sampling at each non-first level includes fusing a decoding feature, obtained from up-sampling at a previous level, with an encoding feature of a same sampling parameter to obtain a fused feature, and performing up-sampling on the fused feature; and a process of obtaining a fused feature of at least one non-first level includes fusing a decoding feature, obtained from up-sampling at a previous level, with an encoding feature of a same sampling parameter according to a pre-learned fusion parameter.

Various embodiments of the present disclosure provide a non-transitory computer-readable storage medium containing a computer program that, when being executed, causes one or more processors to perform an image enhancement method. The image enhancement method includes performing down-sampling at a plurality of levels on a first image to obtain a plurality of encoding features with different sampling parameters; performing up-sampling at a plurality of levels on an encoding feature, obtained from down-sampling at a last level, to obtain a plurality of decoding features with different sampling parameters; and obtaining a second image based on a decoding feature obtained from up-sampling at a last level, where a resolution of the second image is higher than a resolution of the first image. Up-sampling at each non-first level includes fusing a decoding feature, obtained from up-sampling at a previous level, with an encoding feature of a same sampling parameter to obtain a fused feature, and performing up-sampling on the fused feature; and a process of obtaining a fused feature of at least one non-first level includes fusing a decoding feature, obtained from up-sampling at a previous level, with an encoding feature of a same sampling parameter according to a pre-learned fusion parameter.

Compared with the existing technology, the technical solutions provided by the present disclosure may achieve at least the following beneficial effects.

For the image enhancement method, the image enhancement device, the image enhancement model, the training method of the image enhancement model, the electronic device and the storage medium provided by the present disclosure, down-sampling at the plurality of levels may be performed on the first image of relatively low resolution to obtain the plurality of encoding features with different sampling parameters; up-sampling at the plurality of levels may be performed on the encoding feature obtained from down-sampling the last level to obtain the plurality of decoding features with different sampling parameters; and the second image of relatively high resolution may be obtained based on the decoding feature obtained from up-sampling at the last level. Up-sampling at each non-first level may include obtaining the fused feature by fusing the decoding feature obtained from up-sampling at previous level with the encoding feature of the same sampling parameter and performing up-sampling on the fused feature. The process of obtaining the fused feature of at least one non-first level may include fusing the decoding feature obtained from up-sampling at previous level with the encoding feature of the same sampling parameter using the pre-trained fusion parameter.

Those skilled in the art may understand that exemplary units and algorithmic steps described in various embodiments of the present disclosure may be implemented using electronic hardware, or a combination of computer software and electronic hardware. Whether such functions are implemented in hardware or software may depend on certain application and design constraints of the technical solutions. Those skilled in the art may implement described functions using different manners for each certain application, but such implementations should not be considered beyond the protection scope of the present disclosure.

In some embodiments provided in the present disclosure, it may be understood that disclosed systems, devices, and methods may be implemented in other manners. Furthermore, the couplings, direct couplings, or communication connections shown or discussed may be through interfaces, indirect couplings, or communication connections between devices or units; and may be electrical, mechanical, or other forms.

The units described as separate components may or may not be physically separated. The components described as display units may or may not be physical units, that is, may be in a single location or distributed across the plurality of network units. Some or all units may be selected to achieve the objectives of the present embodiments as needed.

Furthermore, each functional unit in various embodiments of the present disclosure may be integrated into a single processing unit; each unit may exist physically separately; or two or more units may be integrated into a single unit.

It may be understood that in embodiments of the present disclosure, dependent claims, various embodiments, and features may be combined and integrated to solve above-mentioned technical problems.

In response to that the functions described are implemented as software functional units and sold or used as standalone products, the functions may be stored in a computer-readable storage medium. Based on such understanding, the essence of the technical solution of the present disclosure, or a part of the technical solution which may contribute to the existing technology, or a part of the technical solution may be embodied in the form of a software product. The computer software product may be stored in a storage medium and include certain instructions for a computer device (which may be a personal computer, a server, or a network device or the like) to perform all or part of exemplary steps of the methods described in each embodiment of the present disclosure. Above-mentioned storage media may include various media capable of storing program codes, including U disk, mobile hard disk, read-only memory (ROM), random access memory (RAM), disk, optical disk or the like.

The above description of disclosed embodiments may enable those skilled in the art to implement or use the present disclosure. Various modifications to embodiments of the present disclosure may be readily apparent to those skilled in the art, and general principles defined herein may be implemented in other embodiments without departing from the spirit or scope of the present disclosure. Therefore, the present disclosure may be not limited to embodiments of the present disclosure herein but may be intended to conform to the broadest scope consistent with the principles and novel features disclosed herein.

What is claimed is:

1. An image enhancement method, comprising:
performing down-sampling at a plurality of levels on a first image to obtain a plurality of encoding features with different sampling parameters;
performing up-sampling at a plurality of levels on an encoding feature, obtained from down-sampling at a last level, to obtain a plurality of decoding features with different sampling parameters, wherein up-sampling at each non-first level includes fusing a decoding feature, obtained from up-sampling at a previous level, with an encoding feature of a same sampling parameter to obtain a fused feature, and performing up-sampling on the fused feature; and a process of obtaining a fused feature of at least one non-first level includes fusing a decoding feature, obtained from up-sampling at a previous level, with an encoding feature of a same sampling parameter according to a pre-learned fusion parameter; and
obtaining a second image based on a decoding feature obtained from up-sampling at a last level, wherein a resolution of the second image is higher than a resolution of the first image.

2. The method according to claim 1, wherein fusing the decoding feature, obtained from up-sampling at the previous level, with the encoding feature of the same sampling parameter according to the pre-learned fusion parameter includes:
based on the fusion parameter, the decoding feature obtained from up-sampling at the previous level, and the encoding feature of the same sampling parameter, calculating a first weight of the encoding feature having the same sampling parameter as the decoding feature obtained from up-sampling at the previous level; and
performing weighted fusion on the decoding feature obtained from up-sampling at the previous level and the encoding feature of the same sampling parameter based on the first weight.

3. The method according to claim 2, wherein performing the weighted fusion on the decoding feature obtained from up-sampling at the previous level and the encoding feature of the same sampling parameter based on the first weight includes:
obtaining a second weight of the decoding feature obtained from up-sampling at the previous level based on the first weight; and
based on the first weight and the second weight, performing weighted calculation on the decoding feature obtained from up-sampling at the previous level and the encoding feature of the same sampling parameter.

4. The method according to claim 2, wherein performing the weighted fusion on the decoding feature obtained from up-sampling at the previous level and the encoding feature of the same sampling parameter based on the first weight includes:
summing the decoding feature obtained from up-sampling at the previous level and the encoding feature of the same sampling parameter to obtain an initial fused feature;
obtaining a second weight of the decoding feature obtained from up-sampling at the previous level based on the first weight; and
based on the first weight and the second weight, performing weighted calculation on the initial fused feature and the decoding feature obtained from up-sampling at the previous level.

5. The method according to claim 1, wherein the process of performing down-sampling at the plurality of levels on the first image, performing up-sampling at the plurality of levels on the encoding feature obtained from down-sampling at the last level, and obtaining the second image based on the decoding feature obtained from up-sampling at the last level includes:
performing down-sampling at the plurality of levels on the first image using a first encoding module of an enhancement network;
performing up-sampling at the plurality of levels on the encoding feature obtained from down-sampling at the last level using a decoding module of the enhancement network, wherein
up-sampling at each non-first level includes obtaining the fused feature by fusing the decoding feature, obtained from up-sampling at the previous level, with the encoding feature of the same sampling parameter using a fusion module of the enhancement network, and performing up-sampling on the fused feature; and the process of obtaining the fused feature of at least one non-first level includes, by the fusion module, fusing the decoding feature, obtained from up-sampling at the previous level, with the encoding feature of the same sampling parameter according to the pre-learned fusion parameter; and
processing the decoding feature obtained from up-sampling at the last level to obtain the second image using an output module of the enhancement network.

6. The method according to claim 5, wherein the enhancement network is obtained by a training manner including:
based on high-quality images in a first image set, performing unsupervised training on an initial network obtained from a second encoding module, the decoding module, and the output module to obtain a pre-trained network, wherein the first image set includes a plurality of low-quality images and high-quality images corresponding to all low-quality images; and the second encoding module is configured to perform down-sampling at a plurality of levels on a high-quality image inputted to obtain a plurality of encoding features with different sampling parameters; and
based on the pre-trained network, performing supervised training on the first encoding module and the fusion module using the first image set to obtain a trained first encoding module and a trained fusion module, wherein the trained first encoding module, the trained fusion module, and the decoding module and the output module in the pre-trained network form the enhanced network.

7. The method according to claim 6, wherein based on the pre-trained network, performing supervised training on the first encoding module using the first image set includes:
for any low-quality image in the first image set, inputting any low-quality image into the first encoding module to obtain a plurality of encoding features with different sampling parameters of any low-quality image;
inputting a high-quality image corresponding to any low-quality image into the second encoding module in the pre-trained network to obtain a plurality of encoding features with different sampling parameters of the high-quality image corresponding to any low-quality image; and
updating a parameter of the first encoding module with a goal of minimizing a first difference between an encoding feature of any low-quality image and an encoding feature which is of the high-quality image corresponding to any low-quality image and has a same sampling parameter as the encoding feature of any low-quality image.

8. An electronic device, comprising:
a memory, configured to store a computer program; and
one or more processors, configured to, when the computer program is executed, perform:
performing down-sampling at a plurality of levels on a first image to obtain a plurality of encoding features with different sampling parameters;
performing up-sampling at a plurality of levels on an encoding feature, obtained from down-sampling at a last level, to obtain a plurality of decoding features with different sampling parameters, wherein up-sampling at each non-first level includes fusing a decoding feature, obtained from up-sampling at a previous level, with an encoding feature of a same sampling parameter to obtain a fused feature, and performing up-sampling on the fused feature; and a process of obtaining a fused feature of at least one non-first level includes fusing a decoding feature, obtained from up-sampling at a previous level, with an encoding feature of a same sampling parameter according to a pre-learned fusion parameter; and
obtaining a second image based on a decoding feature obtained from up-sampling at a last level, wherein a resolution of the second image is higher than a resolution of the first image.

9. The electronic device according to claim 8, wherein for fusing the decoding feature, obtained from up-sampling at the previous level, with the encoding feature of the same sampling parameter according to the pre-learned fusion parameter, the one or more processors are further configured to perform:
based on the fusion parameter, the decoding feature obtained from up-sampling at the previous level, and the encoding feature of the same sampling parameter, calculating a first weight of the encoding feature having the same sampling parameter as the decoding feature obtained from up-sampling at the previous level; and
performing weighted fusion on the decoding feature obtained from up-sampling at the previous level and the encoding feature of the same sampling parameter based on the first weight.

10. The electronic device according to claim 9, wherein for performing the weighted fusion on the decoding feature obtained from up-sampling at the previous level and the encoding feature of the same sampling parameter based on the first weight, the one or more processors are further configured to perform:
obtaining a second weight of the decoding feature obtained from up-sampling at the previous level based on the first weight; and
based on the first weight and the second weight, performing weighted calculation on the decoding feature obtained from up-sampling at the previous level and the encoding feature of the same sampling parameter.

11. The electronic device according to claim 9, wherein for performing the weighted fusion on the decoding feature obtained from up-sampling at the previous level and the encoding feature of the same sampling parameter based on the first weight, the one or more processors are further configured to perform:
summing the decoding feature obtained from up-sampling at the previous level and the encoding feature of the same sampling parameter to obtain an initial fused feature;
obtaining a second weight of the decoding feature obtained from up-sampling at the previous level based on the first weight; and
based on the first weight and the second weight, performing weighted calculation on the initial fused feature and the decoding feature obtained from up-sampling at the previous level.

12. The electronic device according to claim 8, wherein for the process of performing down-sampling at the plurality of levels on the first image, performing up-sampling at the plurality of levels on the encoding feature obtained from down-sampling at the last level, and obtaining the second image based on the decoding feature obtained from up-sampling at the last level, the one or more processors are further configured to perform:
performing down-sampling at the plurality of levels on the first image using a first encoding module of an enhancement network;
performing up-sampling at the plurality of levels on the encoding feature obtained from down-sampling at the last level using a decoding module of the enhancement network, wherein
up-sampling at each non-first level includes obtaining the fused feature by fusing the decoding feature, obtained from up-sampling at the previous level, with the encoding feature of the same sampling parameter using a fusion module of the enhancement network, and performing up-sampling on the fused feature; and the process of obtaining the fused feature of at least one non-first level includes, by the fusion module, fusing the decoding feature, obtained from up-sampling at the previous level, with the encoding feature of the same sampling parameter according to the pre-learned fusion parameter; and
processing the decoding feature obtained from up-sampling at the last level to obtain the second image using an output module of the enhancement network.

13. The electronic device according to claim 12, wherein the enhancement network is obtained by a training manner including:
based on high-quality images in a first image set, performing unsupervised training on an initial network obtained from a second encoding module, the decoding module, and the output module to obtain a pre-trained network, wherein the first image set includes a plurality of low-quality images and high-quality images corresponding to all low-quality images; and the second encoding module is configured to perform down-sampling at a plurality of levels on a high-quality image inputted to obtain a plurality of encoding features with different sampling parameters; and
based on the pre-trained network, performing supervised training on the first encoding module and the fusion module using the first image set to obtain a trained first encoding module and a trained fusion module, wherein the trained first encoding module, the trained fusion module, and the decoding module and the output module in the pre-trained network form the enhanced network.

14. The electronic device according to claim 13, wherein for based on the pre-trained network, performing supervised training on the first encoding module using the first image set, the one or more processors are further configured to perform:
for any low-quality image in the first image set, inputting any low-quality image into the first encoding module to obtain a plurality of encoding features with different sampling parameters of any low-quality image;
inputting a high-quality image corresponding to any low-quality image into the second encoding module in the pre-trained network to obtain a plurality of encoding features with different sampling parameters of the high-quality image corresponding to any low-quality image; and
updating a parameter of the first encoding module with a goal of minimizing a first difference between an encoding feature of any low-quality image and an encoding feature which is of the high-quality image corresponding to any low-quality image and has a same sampling parameter as the encoding feature of any low-quality image.

15. A non-transitory computer-readable storage medium containing a computer program that, when being executed, causes one or more processors to perform:
performing down-sampling at a plurality of levels on a first image to obtain a plurality of encoding features with different sampling parameters;
performing up-sampling at a plurality of levels on an encoding feature, obtained from down-sampling at a last level, to obtain a plurality of decoding features with different sampling parameters, wherein up-sampling at each non-first level includes fusing a decoding feature, obtained from up-sampling at a previous level, with an encoding feature of a same sampling parameter to obtain a fused feature, and performing up-sampling on the fused feature; and a process of obtaining a fused feature of at least one non-first level includes fusing a decoding feature, obtained from up-sampling at a previous level, with an encoding feature of a same sampling parameter according to a pre-learned fusion parameter; and
obtaining a second image based on a decoding feature obtained from up-sampling at a last level, wherein a resolution of the second image is higher than a resolution of the first image.

16. The storage medium according to claim 15, wherein for fusing the decoding feature, obtained from up-sampling at the previous level, with the encoding feature of the same sampling parameter according to the pre-learned fusion parameter, the one or more processors are further configured to perform:
based on the fusion parameter, the decoding feature obtained from up-sampling at the previous level, and the encoding feature of the same sampling parameter, calculating a first weight of the encoding feature having the same sampling parameter as the decoding feature obtained from up-sampling at the previous level; and
performing weighted fusion on the decoding feature obtained from up-sampling at the previous level and the encoding feature of the same sampling parameter based on the first weight.

17. The storage medium according to claim 16, wherein for performing the weighted fusion on the decoding feature obtained from up-sampling at the previous level and the encoding feature of the same sampling parameter based on the first weight, the one or more processors are further configured to perform:
obtaining a second weight of the decoding feature obtained from up-sampling at the previous level based on the first weight; and
based on the first weight and the second weight, performing weighted calculation on the decoding feature obtained from up-sampling at the previous level and the encoding feature of the same sampling parameter.

18. The storage medium according to claim 16, wherein for performing the weighted fusion on the decoding feature obtained from up-sampling at the previous level and the encoding feature of the same sampling parameter based on the first weight, the one or more processors are further configured to perform:
summing the decoding feature obtained from up-sampling at the previous level and the encoding feature of the same sampling parameter to obtain an initial fused feature;
obtaining a second weight of the decoding feature obtained from up-sampling at the previous level based on the first weight; and
based on the first weight and the second weight, performing weighted calculation on the initial fused feature and the decoding feature obtained from up-sampling at the previous level.

19. The storage medium according to claim 15, wherein for the process of performing down-sampling at the plurality of levels on the first image, performing up-sampling at the plurality of levels on the encoding feature obtained from down-sampling at the last level, and obtaining the second image based on the decoding feature obtained from up-sampling at the last level, the one or more processors are further configured to perform:
performing down-sampling at the plurality of levels on the first image using a first encoding module of an enhancement network;
performing up-sampling at the plurality of levels on the encoding feature obtained from down-sampling at the last level using a decoding module of the enhancement network, wherein
up-sampling at each non-first level includes obtaining the fused feature by fusing the decoding feature, obtained from up-sampling at the previous level, with the encoding feature of the same sampling parameter using a fusion module of the enhancement network, and
performing up-sampling on the fused feature; and the process of obtaining the fused feature of at least one non-first level includes, by the fusion module, fusing the decoding feature, obtained from up-sampling at the previous level, with the encoding feature of the same sampling parameter according to the pre-learned fusion parameter; and
processing the decoding feature obtained from up-sampling at the last level to obtain the second image using an output module of the enhancement network.

20. The storage medium according to claim 19, wherein the enhancement network is obtained by a training manner including:
based on high-quality images in a first image set, performing unsupervised training on an initial network obtained from a second encoding module, the decoding module, and the output module to obtain a pre-trained network, wherein the first image set includes a plurality of low-quality images and high-quality images corresponding to all low-quality images; and the second encoding module is configured to perform down-sampling at a plurality of levels on a high-quality image inputted to obtain a plurality of encoding features with different sampling parameters; and
based on the pre-trained network, performing supervised training on the first encoding module and the fusion module using the first image set to obtain a trained first encoding module and a trained fusion module, wherein the trained first encoding module, the trained fusion module, and the decoding module and the output module in the pre-trained network form the enhanced network.
